(19) United States
(12) Patent Application Publication
(10) Pub. No.: US 2026/0244046 A1
(43) Pub. Date: Aug. 20, 2026

(54) DISPLAY APPARATUS, HEAD-UP DISPLAY APPARATUS, AND VEHICLE

(71) Applicant: SEIKO EPSON CORPORATION, Tokyo (JP)

(72) Inventor: Akira SHINBO, SHIOJIRI-SHI (JP)

(21) Appl. No.: 19/541,563

(22) Filed: Feb. 17, 2026

(30) Foreign Application Priority Data
Feb. 18, 2025 (JP) 2025-024031

(51) Int. Cl. G02F 1/1333; B60K 35/23

(52) U.S. Cl. CPC G02F 1/13336; B60K 35/23; G02F 1/133308

(57) ABSTRACT

A display apparatus includes a first display element and a second display element arranged in an X direction; and a first lens member and a second lens member disposed so as to face and cover the first display element and the second display element, respectively, in a plan view, a gap being formed between a display region of the first display element and a display region of the second display element, the lens members each having an edge portion disposed so as to cover the gap in the plan view, the edge portion having a convex surface on a side opposite the display element, the convex surface deflects display light output from a vicinity of the gap in the display region in a forward direction with respect to the display element, and a relationship below is satisfied,
R1<R2
   where R1 represents a radius of curvature of the convex surface at a base end, and R2 represents a radius of curvature of the convex surface at a tip.

The present application is based on, and claims priority from JP Application Serial Number 2025-024031, filed Feb. 18, 2025, the disclosure of which is hereby incorporated by reference herein in its entirety.

### BACKGROUND

### 1. Technical Field

The present disclosure relates to a display apparatus configured with multiple display elements, and a head-up display apparatus and a vehicle each including the display apparatus.

### 2. Related Art

When a large screen is configured by arranging multiple display panels, to prevent a bezel of each of the display panels from being seen, there is a known display apparatus provided with a lens portion having an upper convex surface at the edge of a light transmissive cover disposed on an observer's side of the display panel (WO 2010/140537).

WO 2010/140537 is an example of the related art.

In the display apparatus of the related art described above, the radius of curvature of the lens portion is greater in the portion facing the display region than in the portion facing the bezel, that is, the edge region, or is fixed throughout the portion facing the edge region and the portion facing the display region. In this case, it is necessary to increase the width of the lens portion, resulting in an increase in the distortion region of an observed image where distortion occurs due to the change in magnification of the lens portion, and the distortion is likely to be noticeable in the image of the boundary between the display region and the edge region.

### SUMMARY

A display apparatus according to an aspect of the present disclosure includes: a first display element and a second display element arranged in a predetermined direction; and a first lens member and a second lens member disposed so as to face and cover the first display element and the second display element, respectively, in a plan view, a gap is formed between a display region of the first display element and a display region of the second display element, the lens members each have an edge portion disposed so as to cover the gap in the plan view, the edge portion has a convex surface configured to deflect light output from a vicinity of the gap in the display region in a forward direction with respect to the display element toward a side opposite the display element, and a relationship below is satisfied,
R1<R2
   where R1 represents a radius of curvature of the convex surface at a base end, and R2 represents a radius of curvature of the convex surface at a tip.

A head-up display apparatus according to an aspect of the present disclosure includes: the display apparatus described above; and a light transmissive mirror disposed so as to face and incline with respect to the display apparatus.

A vehicle according to an aspect of the present disclosure includes the head-up display apparatus described above.

### BRIEF DESCRIPTION OF THE DRAWINGS

FIG. 1 illustrates a display apparatus, a head-up display apparatus, and the like according to a first embodiment.

FIG. 2 is a plan view illustrating the display apparatus.

FIG. 3 is a partially enlarged cross-sectional view illustrating an example of a display optical system that constitutes the display apparatus.

FIG. 4 is a conceptual view illustrating optical characteristics of a lens portion and the like of the display optical system.

FIG. 5 is a partially enlarged cross-sectional view illustrating another example of the display optical system that constitutes the display apparatus.

FIG. 6 is a partially enlarged cross-sectional view illustrating the display optical system in Comparative Example.

FIG. 7 is a table illustrating a refraction width in Examples and Comparative Example.

FIG. 8 is a chart showing the relationship between a major-axis radius and the refraction width.

FIG. 9 is a partially enlarged cross-sectional view of a display apparatus and the like according to a second embodiment.

FIG. 10 is a partially enlarged cross-sectional view illustrating Comparative Example with respect to the second embodiment.

FIG. 11 illustrates simulated luminance distributions.

### DESCRIPTION OF EMBODIMENTS

### First embodiment

A display apparatus, a head-up display apparatus, and the like of a first embodiment according to the present disclosure will be described below with reference to the drawings.

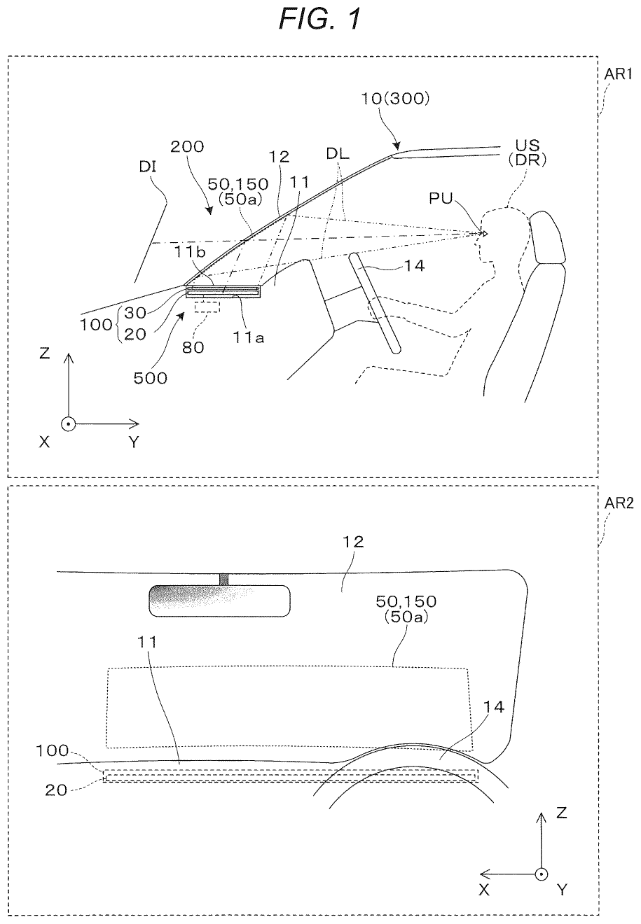

FIG. 1 is a conceptual view illustrating a head-up display apparatus 200 and a vehicle 300 equipped with the same. A region AR1 in FIG. 1 is a conceptual side cross-sectional view illustrating the head-up display apparatus 200 and the like. A region AR2 in FIG. 1 is a conceptual view illustrating the structure and the functions of the head-up display apparatus 200.

The head-up display apparatus 200 is incorporated in the vehicle 300, for example, an automobile 10, and includes a video projector 500 and a light transmissive mirror 50. The video projector 500 displays any image. A driver DR, who is an observer US, observes the image displayed by the video projector 500 via the light transmissive mirror 50, which is a mirror portion 150. Note that the vehicle 300 includes, although not shown, an engine and other drive mechanisms that cause the vehicle 300 to travel.

The video projector 500 includes a plate-shaped display apparatus 100 elongated in an X direction and a display controller 80, which controls a display operation of the display apparatus 100. The display apparatus 100 includes a display 20, which displays an image, and a sheet-shaped optical member 30 disposed in the vicinity of the upper side of the display 20. The display 20 has a laterally elongated, rectangular-plate-shaped contour, and the display apparatus 100, which is the combination of the display 20 and the sheet-shaped optical member 30, also has a laterally elongated, rectangular-plate-shaped contour. The display apparatus 100 is covered with a sheet-shaped transparent protective cover 11b provided at the upper end of a recess 11a.

The display apparatus 100 is installed so as to be fitted into the recess 11a provided in a dashboard 11 of the automobile 10, and outputs display light DL, which corresponds to an image containing driving-related information or the like, upward to a portion where the light transmissive mirror 50 is located. The display apparatus 100 is covered with the sheet-shaped transparent protective cover 11b provided at the upper end of the recess 11a. The light transmissive mirror 50 is a film-shaped member attached to the inner surface of a windshield 12, and is disposed above the display apparatus 100 so as to face the display apparatus 100. The transmittance of the light transmissive mirror 50 is set, for example, to 75%, but is not limited thereto. The light transmissive mirror 50 may be the inner surface of the windshield 12. As the mirror portion 150, the light transmissive mirror 50 may be replaced with a 100%-reflection mirror.

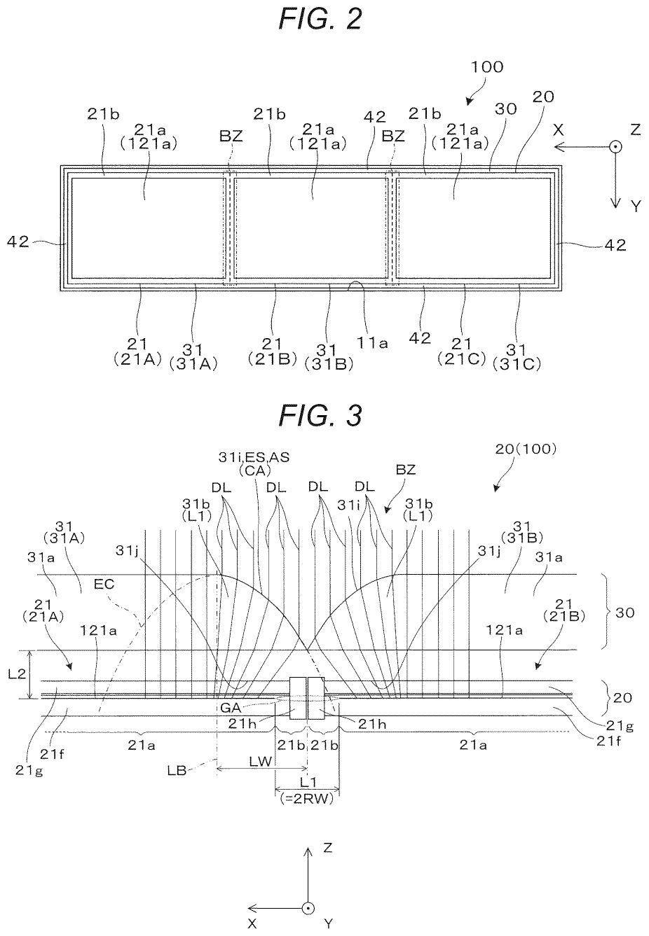

FIG. 2 is a conceptual plan view of the display apparatus 100. Out of the elements of the display apparatus 100, the display 20 includes three rectangular display elements 21, specifically, a first display element 21A, a second display element 21B, and a third display element 21C, and the three display elements 21A, 21B, and 21C are arranged in the lateral direction, that is, the X direction. The display elements 21 each include a display portion 21a, which forms an image, and an edge 21b, which is an outer frame. The display portion 21a has a display region 121a within a range that coincides with the contour of the display portion 21a in the plan view. The edge 21b corresponds to a non-display region present outside the display region 121a. Due to the presence of the edge 21b, the three display portions 21a, that is, the three display regions 121a are disposed slightly apart from each other in the X direction. The sheet-shaped optical member 30 includes three rectangular lens members 31, specifically, a first lens member 31A, a second lens member 31B, and a third lens member 31C, and the three lens members 31A, 31B, and 31C are arranged in the lateral direction, that is, the X direction. The three lens members 31A, 31B, and 31C are supported by a frame-shaped support member 42, are respectively positioned with respect to the three display elements 21A, 21B, and 21C, and are disposed above the display elements, that is, at positions shifted in the Z direction. That is, the lens members 31A, 31B, and 31C are disposed so as to face and cover the display elements 21A, 21B, and 21C, respectively, in the plan view. The display elements 21 and the lens members 31 have substantially the same size in the plan view. That is, the lens members 31 are each slightly larger than the display portion 21a of the corresponding display element 21 approximately by the width of the edge 21b. In the above description, a boundary region BZ is formed between the first display element 21A and the second display element 21B and between the second display element 21B and the third display element 21C. It is desirable that each of the boundary regions BZ is a joint of images, is not noticeable in appearance, and has a small lateral width.

FIG. 3 is an enlarged front cross-sectional view of the boundary region BZ between the first display element 21A and the second display element 21B and a region around the boundary region BZ in the display apparatus 100. The first display element 21A includes a body portion 21f, a cover glass portion 21g, and a frame member 21h. The second display element 21B is structured in the same manner as the first display element 21A. When the display elements 21A and 21B are each, for example, an organic EL display element, the body portions 21f each include a substrate, an electrode layer provided on the substrate with the electrode layer having being patterned, a light emitting layer that forms pixels, a sealing layer that covers the entire structure, and the like, although detailed description of none of which will be made. The frame member 21h of the first display element 21A is made of resin or metal, protects the outer circumference of the first display element 21A, and is used, for example, to fix the first display element 21A to another member.

The display region 121a is present in each of the first display element 21A and the second display element 21B. When the display elements 21A and 21B are each, for example, an organic EL (electro luminescence) display element, the display region 121a corresponds to a light emitting layer region configured with a group of pixels arranged in a matrix. The display light DL is output from the display region 121a. That is, the display region 121a corresponds to an effective display region of each of the display elements 21A and 21B and defines the display portion 21a. Out of the display elements 21A and 21B, the outer side of the display portion 21a or the display region 121a in the lateral direction or the XY direction is the edge 21b. At the edge 21b, a gap GA is formed between the first display element 21A and the second display element 21B adjacent to each other.

In the example shown in FIG. 3, the display light DL is output in the boundary region BZ in directions inclining with respect to the display region 121a and in the forward direction with respect to the display region 121a. Note that when a microlens is provided, for example, for each of the pixels of the display region 121a, the display light DL can be output primarily in an intended direction.

The first lens member 31A is made of a light transmissive resin material, and includes a planar plate portion 31a and an edge portion 31b. The second lens member 31B is structured in the same manner as the first lens member 31A.

In each of the lens members 31A and 31B, the planar plate portion 31a is a plane-parallel-plate-shaped portion, and has a lateral width in the display element arrangement direction or the X direction, the lateral width being smaller than that of the display portion 21a or the display region 121a of each of the display elements 21A and 21B.

The edge portion 31b is a lens portion similar to a cylindrical lens, but the curvature of the optical surface of the edge portion 31b is position variant in the X direction. More specifically, the edge portion 31b is a planoconvex lens L1 having a convex surface 31i on the upper side, that is, on the side opposite the display elements 21A and 21B, and a planar surface 31j on the lower side, that is, on the side facing the display elements 21A and 21B. The edge portion 31b extends outward in the display element arrangement direction beyond the display portion 21a or the display region 121a of each of the display elements 21A and 21B. That is, the edge portion 31b is disposed so as to straddle the outer edge of the display region 121a in the X direction.

The convex surface 31i of the edge portion 31b is a surface corresponding to the trajectory of a curve CA, which is upwardly convex in the XZ cross section, translated in the frontward-rearward Y direction. Specifically, the curve CA is, for example, a portion of an ellipse EC, and in this case, the convex surface 31i is an elliptical surface ES. The curve CA may be expressed, for example, by the following aspherical expression:
where
z: amount of displacement in the Z direction,
c: curvature (1/R),
h: height in the X direction from the optical axis or a boundary line LB,
k: conic coefficient, and
Ai: i-th order aspherical coefficient

In this case, the convex surface 31i is an aspherical surface AS. In the aspherical expression, when a conic coefficient k<0 and the coefficient Ai at each order is zero, the curve CA or the aspherical surface AS is the ellipse EC or the elliptical surface ES.

The edge portion 31b deflects the display light DL output from the vicinity of the gap GA in the display region 121a in the +Z direction, which is the forward direction with respect to the display elements 21A and 21B. That is, in a region away from the gap GA out of the display region 121a of each of the display elements 21A and 21B, even when the display light DL output in the +Z direction passes through the planar plate portion 31a of each of the lens members 31A and 31B, the display light DL is maintained in parallel to the +Z direction, which is the forward direction, and the display light DL output outward, that is, in the ±X direction in the vicinity of the gap GA out of the display region 121a of each of the display elements 21A and 21B passes through the edge portion 31b of each of the lens members 31A and 31B, so that the display light DL is deflected in parallel to the +Z direction, which is the forward direction. As a result, irrespective of the fact that the gap GA is present, any missing portion of the image is unlikely to be recognized by the observer. In the image, however, a portion produced by the edge portion 31b, that is, a portion recognized to be in the gap GA or in the vicinity thereof is slightly distorted in the lateral direction, that is, the X direction. However, when a width LW of the edge portion 31b is small, the distortion of the image due to the edge portion 31b is not noticeable. When reverse distortion correction is performed on the displayed image in a region of the display region 121a that is the region facing the edge portion 31b, the distortion of the image due to the edge portion 31b is canceled out, so that the distortion of the image is less noticeable.

Let L1 be the distance between the display region 121a of the first display element 21A and the display region 121a of the second display element 21B, and L2 be the distance from the display regions 121a of the first display element 21A and the second display element 21B to the first lens member 31A and the second lens member 31B, and the following relationship
L2<L1
   is satisfied. When the relationship is satisfied, the lens members 31A and 31B can be brought close to the display elements 21A and 21B, so that the thickness of the display apparatus 100 can be reduced.

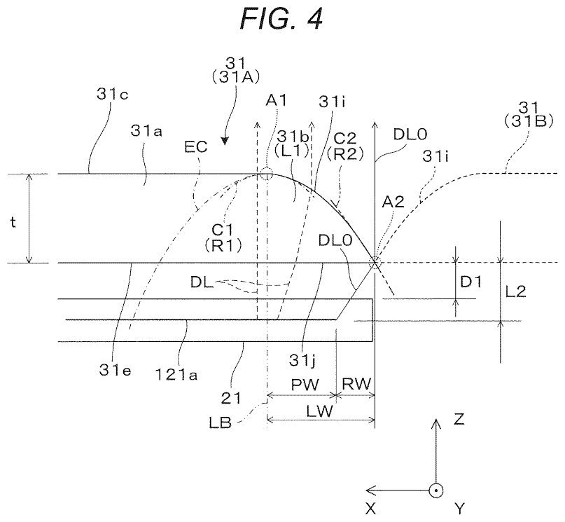

FIG. 4 illustrates the shape and arrangement of the first lens member 31A, that is, each of the lens members 31. In FIG. 4, t represents the thickness of the lens member 31, D1 represents the width of the gap between the display element 21 and the lens member 31, L2 represents the distance from the display region 121a to the planar surface 31j of the lens member 31, that is, the gap therebetween, and RW represents the distance from the outer edge of the display region 121a to the boundary between the lens members 31A and 31B. The distance RW is also referred to as a refraction width. Twice the refraction width RW or 2RW is equal to the distance L1 shown in FIG. 3, and corresponds to the gap GA between the pair of adjacent display regions 121a. Display light DL0 incident on a tip A2, which is the end in the −X direction, from the end of the display region 121a in the −X direction is deflected in the forward direction with respect to the display element 21, that is, in the +Z direction. That is, the value 2RW=L1 corresponds to a theoretical gap that makes the pair of adjacent display regions 121a recognized as linked to each other without overlap. Specific theoretical values in the display apparatus 100 shown in FIG. 3 are as follows: the thickness t of the lens members 31 is 1.2 mm; the gap width D1 of the gap between the display elements 21 and the lens members 31 is 0.5 mm; the distance L2 is 0.7 mm; and the refraction width RW=L1/2 is 0.417 mm. The lens members 31 are made of PMMA (refractive index=1.49). Note that the convex surface 31i of each of the lens members 31 has an elliptical shape having a minor-axis radius of 2.5 mm and a major-axis radius of 6 mm.

In each of the lens members 31, the convex surface 31i of the edge portion 31b is continuously and smoothly coupled at a base end A1 to an upper planar surface 31c of the planar plate portion 31a. That is, the line representing the shape from the convex surface 31i to the upper planar surface 31c has values differentiated once, that is, values representing the tangential direction that are continuously changing values. The line representing the shape from the convex surface 31i to the upper planar surface 31c, however, has values differentiated twice, that is, values representing the curvature that are discontinuously changing values. Specifically, the inscribed circle or a curvature circle C1 of the convex surface 31i at the base end A1 shows a finite radius of curvature R1, but the upper planar surface 31c has an infinite radius of curvature. The convex surface 31i of the edge portion 31b of the first lens member 31A is coupled to the convex surface 31i or the planar surface 31j of the second lens member 31B at the tip A2. A curvature circle C2 of the convex surface 31i at the tip A2 shows a finite radius of curvature R2. The following relationship is satisfied between the radius of curvature R1 of the convex surface 31i at the base end A1 and the radius of curvature R2 of the convex surface 31i at the tip A2:
R1<R2. That is, the curvature of the convex surface 31i at the base end A1 is greater than the curvature of the convex surface 31i at the tip A2. A lateral width (that is, width in X direction) PW of an inner portion the convex surface 31i of the edge portion 31b that is the inner portion facing the base end A1 can therefore be relatively reduced, so that the lateral width LW of the entire convex surface 31i can be reduced. When the lateral width LW of the entire convex surface 31i is reduced, the lateral width of the boundary region BZ between the first display element 21A and the second display element 21B is reduced, so that a boundary band where distortion occurs in an observed image is narrowed and does not become noticeable. Furthermore, not only is the radius of curvature R1 of the convex surface 31i at the base end A1 smaller than the radius of curvature R2 of the convex surface 31i at the tip A2, but also the radius of curvature of the convex surface 31i gradually increases from the base end A1 toward the tip A2. The distortion of an observed image that is produced by the lens member 31 can thus be continuously smoothed, so that the amount of produced distortion can be reduced.

In the example shown in FIG. 4, the shape of the convex surface 31i is given by the ellipse EC, and the ellipse EC has a major axis that is the boundary line LB at the base end A1, which is the +X-side end. That is, the curvature circle C1 of the convex surface 31i at the base end A1 corresponds to a circle inscribed at the curved surface at the position where the curved surface intersects with the major axis of the ellipse EC, and the curvature circle C2 of the convex surface 31i at the tip A2 corresponds to a circle circumscribed or inscribed at the curved surface at a position between the major axis and the minor axis of the ellipse EC. When the radius of curvature of the convex surface 31i that is actually present is determined or estimated, the curvature circle C1 of the convex surface 31i at the base end A1 is obtained by freely setting three or more points separate from each other in the XZ cross section of the convex surface 31i at the base end A1 and determining a circumscribed circle or an approximate circle containing the three points, and an approximate radius of curvature can be obtained from the thus obtained curvature circle C1. The curvature circle C2 of the convex surface 31i at the tip A2 is also obtained by freely setting three or more points separate from each other in the XZ cross section of the convex surface 31i at the tip A2 and determining a circumscribed circle or an approximate circle containing the three points, and an approximate radius of curvature can be obtained from the thus obtained curvature circle C2.

In the first lens member 31A, the planar surface 31j of the edge portion 31b is coupled to a lower planar surface 31e of the planar plate portion 31a with no step therebetween. That is, the planar surface 31j and the lower planar surface 31e are in the same plane and are continuous with each other.

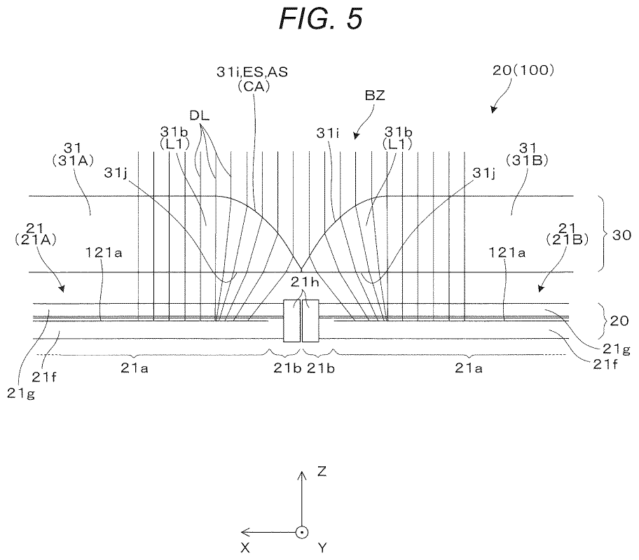

FIG. 5 is an enlarged front cross-sectional view illustrating a variation of the display apparatus 100 shown in FIG. 3. In this case, the convex surface 31i of each of the lens members 31 has an elliptical shape. Specific theoretical values in the variation are as follows: the thickness t of the lens members 31 is 1.2 mm; the gap width D1 of the gap between the display elements 21 and the lens members 31 is 0.5 mm; the distance L2 is 0.7 mm; and the refraction width RW=L1/2 is 0.455 mm (see FIG. 4 for thickness t, gap width D1, and distance L2). The lens members 31 are made of PMMA. Note that the convex surface 31i of each of the lens members 31 has an elliptical shape having a minor-axis radius of 2.5 mm and a major-axis radius of 7.5 mm.

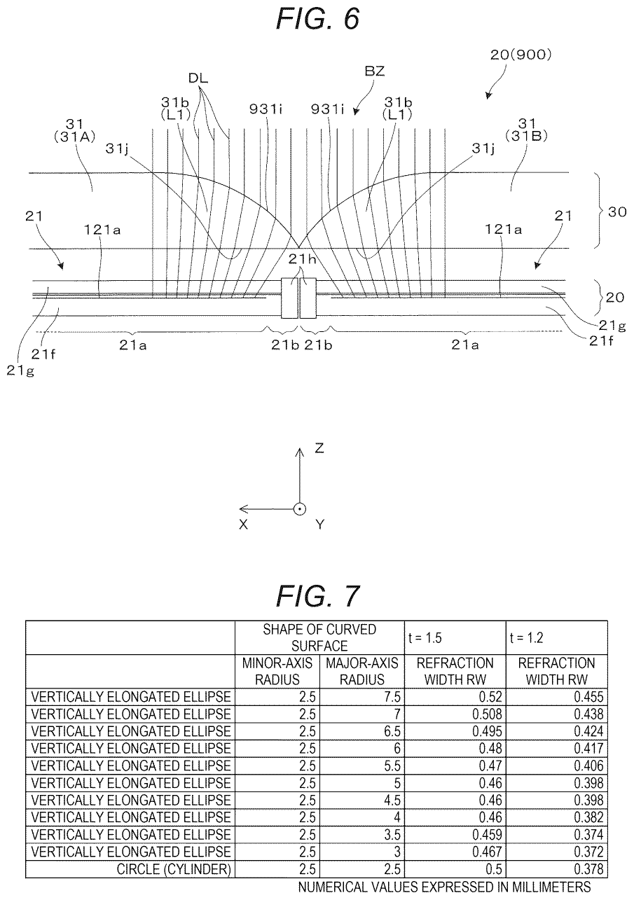

FIG. 6 illustrates a display apparatus 900 according to Comparative Example. In this case, a convex surface 931i of each of the lens members 31 has a circular shape. Specific theoretical values in Comparative Example are as follows: the thickness t of the lens members 31 is 1.2 mm; the gap width D1 of the gap between the display elements 21 and the lens members 31 is 0.5 mm; the distance L2 is 0.7 mm; and the refraction width RW=L1/2 is 0.378 mm (see FIG. 4 for thickness t, gap width D1, and distance L2). The lens members 31 are made of PMMA. Note that the convex surface 931i of each of the lens members 31 has a circular shape having a radius of curvature of 2.5 mm.

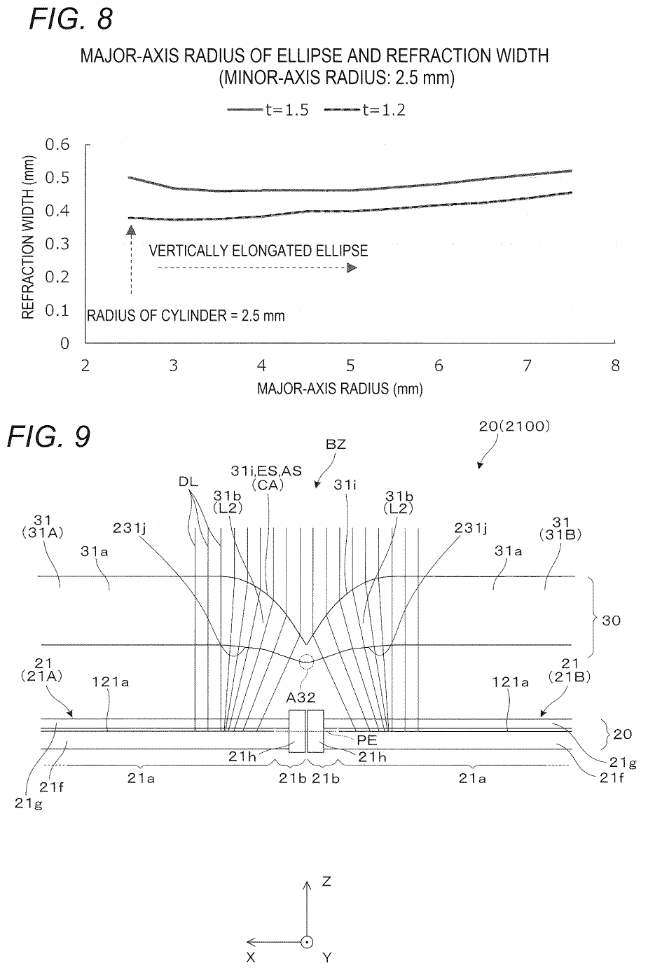

FIG. 7 is a table illustrating specific theoretical values of the shape of the convex surface 31i in each of the display apparatuses 100 and 900 shown in FIGS. 3, 5 and 6 and other display apparatuses. FIG. 8 shows graphs illustrating the results shown in FIG. 7. In the example, a vertically elongated ellipse was used as the shape of the convex surface 31i, and the major-axis radius was changed in the range between 2.5 mm and 7.5 mm with the minor-axis radius set to 2.5 mm. When the thickness t of the lens members 31 is 1.2 mm, the refraction width RW=L1/2 is in a range between 0.372 mm and 0.455 mm. As a result, the refraction width RW=L1/2 is readily increased, and the lateral width LW is readily decreased as compared with that provided by the cylindrical surface (see FIG. 6) having a minor-axis radius considerably greater than that of the cylindrical surface shown in FIG. 3 and the like, which is in contact with the major axis or the apex. When the thickness t of the lens members 31 is 1.5 mm, the refraction width RW=L1/2 is in a range between 0.460 mm and 0.520 mm. As a result, the refraction width RW=L1/2 is readily decreased, and the lateral width LW is readily decreased as compared with that provided by the cylindrical surface having the minor-axis radius.

Although no description using a specific example is made, in the display apparatus 100 according to the example shown in FIG. 3 and the like, a slight increase in luminance occurs in each of the boundary regions BZ, but occurrence of luminance unevenness is suppressed, and the increase in the refraction width RW enlarges an observation region where the bezel, that is, the edge 21b is not visible in oblique directions, so that the boundary is unlikely to be observed when viewed in the oblique directions. In contrast, in the display apparatus 900 according to Comparative Example shown in FIG. 6, the luminance relatively increases in each of the boundary regions BZ, and the luminance unevenness becomes more noticeable.

The shape of the edge portion 31b of the first lens member 31A that is the edge portion provided on the side facing the second lens member 31B has been described above, and it is not necessary to provide a lens surface on the +X side, which is the side opposite the second lens member 31B.

The shape of the edge portion 31b of the first lens member 31A that is the edge portion provided on the side facing the second lens member 31B has been described above, and the shape of the edge portion 31b of the second lens member 31B that is the edge portion provided on the side facing the first lens member 31A is the shape of the edge portion 31b of the first lens member 31A that is horizontally reversed.

The boundary region BZ between the first lens member 31A and the second lens member 31B has been described above, and the boundary region between the second lens member 31B and the third lens member 31C also has the same shape and structure described above.

The optical path and the like in the head-up display apparatus 200 shown in FIG. 1 will be described below. The display light DL from an image formed at the display surface of the display 20 of the display apparatus 100 is partially reflected off the light transmissive mirror 50 and enters a pupil PU of the driver DR. That is, the driver DR can observe the display light DL reflected off the light transmissive mirror 50, that is, a displayed image DI as a virtual image in front of the automobile 10. The display 20 of the video projector 500 includes the multiple display elements 21 arranged in the lateral direction, and a laterally elongated reflective region 50a of the light transmissive mirror 50 extending in the X direction reflects the display light DL from the display elements 21 so as to be visually recognized as a virtual image by the observer US. As a result, the virtual image forms a laterally elongated video having a large aspect ratio.

The driver DR can further observe external light having passed through the light transmissive mirror 50, that is, real images of objects present in front of the driver DR. As a result, the driver DR can observe the displayed image (virtual image) DI formed by the display light DL reflected off the light transmissive mirror 50 and containing various pieces of information such as driving-related information, with the displayed image DI overlapping with an external image or a see-through image behind the windshield 12, as objects behind a steering wheel 14 or the windshield 12.

The display apparatus 100 described above includes the first display element 21A and the second display element 21B arranged in the X direction, and the first lens member 31A and the second lens member 31B disposed so as to face and cover the first display element 21A and the second display element 21B, respectively, in the plan view, the gap GA being formed between the display region 121a of the first display element 21A and the display region 121a of the second display element 21B, the lens members 31 each having the edge portion 31b disposed so as to cover the gap GA in the plan view, the edge portion 31b having the convex surface 31i on the side opposite the display element 21, that is, the +Z side, the convex surface 31i deflects the display light DL0 output from the vicinity of the gap GA in the display region 121a in the forward direction with respect to the display element 21, and the following relationship being satisfied,
R1<R2
   where R1 represents the radius of curvature of the convex surface 31i at the base end A1, and R2 represents the radius of curvature of the convex surface 31i at the tip A2.

In the display apparatus 100 described above, since the radius of curvature R1 at the base end A1 and the radius of curvature R2 at the tip A2 satisfy the relationship of R1<R2, the lateral width of an inner portion of the convex surface 31i of the edge portion 31b that is the inner portion facing the base end A1 can be relatively reduced, and as a result, the overall lateral width of the edge portion 31b in a predetermined direction can be reduced. As a result, a distortion region of the observed image where distortion occurs due to the lens at the edge portion 31b having the convex surface 31i, that is, the boundary band is narrowed and does not become noticeable, which makes the distortion hardly noticeable in the image at the boundary between the pair of display elements 21A and 21B, so that images linked to each other more naturally at the boundary can be displayed.

The head-up display apparatus 200 described above includes the display apparatus 100 described above, and the light transmissive mirror 50 disposed so as to face and incline with respect to the display apparatus 100.

The head-up display apparatus 200 described above, which uses the display apparatus 100 described above, allows observation of a large-screen virtual image, which is difficult to realize with a single display element 21, over a wide viewpoint range.

The vehicle 300 described above includes the head-up display apparatus 200 described above. The vehicle 300 including the head-up display apparatus 200, which is thin and only causes a small amount of image deterioration at the boundary, can thus be realized.

### Second Embodiment

A display apparatus 2100 according to a second embodiment will be described below. The display apparatus 2100 according to the second embodiment is a partially changed version of the display apparatus 100 according to the first embodiment, and the same portions have the same reference characters and will not be described redundantly.

FIG. 9 is an enlarged front cross-sectional view of the boundary region BZ between the first display element 21A and the second display element 21B and a region around the boundary region BZ in the display apparatus 2100 according to the second embodiment. In each of the lens members 31, the edge portion 31b, which is a lens portion, is an upwardly convex positive meniscus lens L2 having the convex surface 31i on the upper side, that is, the side opposite the display element 21, and a concave surface 231j on the lower side, that is, the side facing the display element 21. That is, the edge portion 31b has positive power in the XZ plane. The convex surface 31i is, for example, the elliptical surface ES formed by the ellipse EC, as in the first embodiment, or the aspherical surface AS expressed by the aspherical expression. The concave surface 231j is an elliptical surface expressed by a trajectory of an ellipse in the XZ plane translated in the Y direction, or an aspherical surface expressed by a trajectory of a curve represented by an aspherical expression in the XZ plane and translated in the Y direction. The concave surface 231j may be a cylindrical surface expressed by a trajectory of a circle in the XZ plane translated in the Y direction, a freeform surface expressed by a trajectory of a freeform curve freely drawn in the XZ plane and translated in the Y direction, or the like. In the edge portion 31b of the lens member 31, a tip portion A32 is disposed at the lowermost position and is closest to the display element 21. That is, the lens member 31 is closest to a plane PE, which is an extension of the display region 121a of the display element 21, at the tip of the concave surface 231j, which is the surface facing the display element 21.

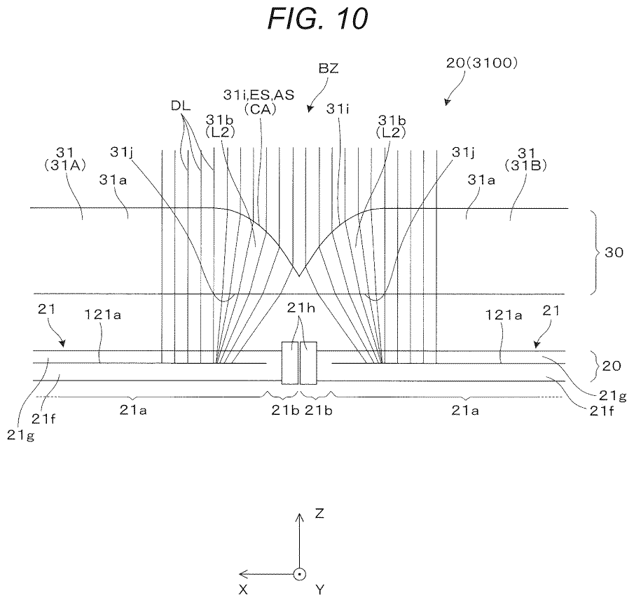

FIG. 10 shows Comparative Example with respect to the display apparatus 2100 according to the second embodiment shown in FIG. 9, and is a front cross-sectional view illustrating a display apparatus 3100 similar to the display apparatus 100 according to the first embodiment. The display apparatus 3100 shown in FIG. 10 is a changed version of the display apparatus 2100 shown in FIG. 9 in which the concave surface 231j is changed to the planar surface 31j, and the distance from the lens member 31 to the positions on the display region 121a of the display element 21 excluding the positions of the ends thereof is the same as that in the display apparatus 2100 shown in FIG. 9. As a result, the planar plate portion 31a of the display apparatus 3100 shown in FIG. 10 is thicker than the planar plate portion 31a of the display apparatus 2100 shown in FIG. 9.

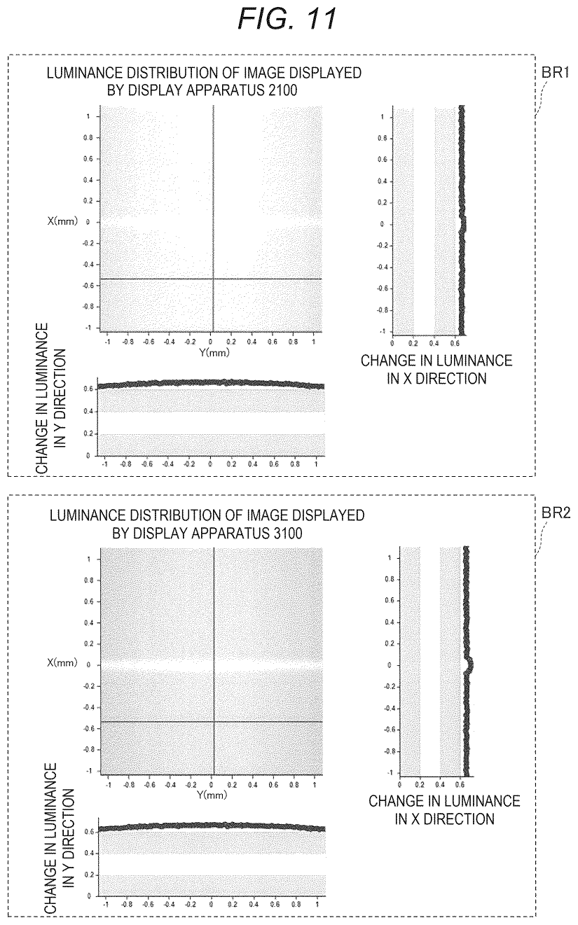

FIG. 11 shows comparison between simulated luminance distributions of displayed images displayed by the display apparatuses 2100 and 3100 shown in FIGS. 9 and 10. A region BR1 in FIG. 11 indicates the luminance distribution of an image displayed by the display apparatus 2100, and a region BR2 in FIG. 11 indicates the luminance distribution of an image displayed by the display apparatus 3100. FIG. 11 shows that X=0 and the vicinity thereof correspond to the boundary region BZ between the display elements 21A and 21B or between the lens members 31A and 31B shown in FIGS. 9 and 10, and have increased luminance. The increase in the luminance in the boundary region BZ is, however, smaller in the display apparatus 2100 than in the display apparatus 3100.

### Other Items

The structures described above are presented by way of example, and can be changed in various manners to the extent that the same functions can be achieved.

The curve CA of the convex surface 31i of the edge portion 31b in the XZ cross section is, for example, a portion of the ellipse EC and the convex surface 31i is the elliptical surface ES. Instead, the curve CA may be a portion of a parabola or a hyperbola, and in this case, the convex surface 31i is a parabolic surface or a hyperbolic surface.

The number of the display apparatuses 100, which constitute the video projector 500, is not limited to three, and may be two or four or more.

The display apparatus 100 may be directly viewed by the observer US.

The observer US is not limited to the driver DR, and may be another passenger sitting on a passenger seat, a backseat, or the like.

The light transmissive mirror 50 may be an independent element installed separately from the windshield 12.

The head-up display apparatus 200 is not necessarily incorporated in the vehicle 300, and can be used for other applications as long as the head-up display apparatus 200 displays a video displayed by any of the display apparatuses 100 and 2100 in the form of a virtual image.

### Summary of Present Disclosure

The present disclosure will be summarized below as additional remarks.

### Additional Remark 1

A display apparatus including:
a first display element and a second display element arranged in a predetermined direction; and
a first lens member and a second lens member disposed so as to face and cover the first display element and the second display element, respectively, in a plan view,
wherein a gap is formed between a display region of the first display element and a display region of the second display element,
the lens members each have an edge portion disposed so as to cover the gap in the plan view,
the edge portion has a convex surface configured to deflect light output from a vicinity of the gap in the display region in a forward direction with respect to the display element toward a side opposite the display element, and
a relationship below is satisfied,
   R1<R2
      where R1 represents a radius of curvature of the convex surface at a base end, and R2 represents a radius of curvature of the convex surface at a tip.

In the display apparatus described above, since the radius of curvature R1 at the base end and the radius of curvature R2 at the tip satisfy the relationship of R1<R2, the lateral width of an inner portion of the convex surface of the edge portion that is the inner portion facing the base end can be relatively reduced, and as a result, the overall lateral width of the edge portion in the predetermined direction can be reduced. As a result, a distortion region of an observed image where distortion occurs due to the lens having the convex surface, that is, a boundary band is narrowed and does not become noticeable, which makes the distortion hardly noticeable in the image at the boundary between the pair of display elements, so that images linked to each other more naturally at the boundary can be displayed.

### Additional Remark 2

The display apparatus according to Additional Remark 1, wherein
a relationship below is satisfied,
L2<L1
   where L1 represents a distance between the display region of the first display element and the display region of the second display element, and L2 represents a distance from the display regions of the first display element and the second display element to the first lens member and the second lens member.

In this case, the lens members can be brought close to the display elements, so that thickness of the display apparatus can be reduced.

### Additional Remark 3

The display apparatus according to Additional Remark 1, wherein
the lens members each have a concave surface on a side facing the display element.

Adding the concave surface to the rear side of the lens of each of the lens members can reduce luminance unevenness at the boundary.

### Additional Remark 4

The display apparatus according to Additional Remark 3, wherein
the concave surface of each of the lens members, which is the surface facing the display element, is closest to a plane that is an extension of the display region.

In particular, the beams output from the display regions in the vicinity of the gap can be greatly refracted while narrowing the gap between the lens members and the display elements between the display elements, so that the edge portions in an image can be efficiently erased.

### Additional Remark 5

The display apparatus according to Additional Remark 1, wherein
the convex surface is an aspherical surface expressed by a conic coefficient k<0.

### Additional Remark 6

The display apparatus according to Additional Remark 5, wherein
the convex surface is an elliptical surface.

When the convex surface is an elliptical surface, the convex surface is simplified in terms of shape and readily processed.

### Additional Remark 7

The display apparatus according to Additional Remark 1, wherein
a radius of curvature of the convex surface gradually increases from the base end toward the tip.

As a result, an observed image has more continuous distortion produced by the lens, and the amount of the produced distortion is also reduced.

### Additional Remark 8

The display apparatus according to Additional Remark 3, wherein
the edge portion is a positive meniscus lens.

Luminance unevenness and distortion of an observed image due to the lens are therefore reduced.

### Additional Remark 9

The display apparatus according to Additional Remark 8, wherein
the concave surface is any one of a cylindrical surface, an aspherical surface, and a freeform surface.

Luminance unevenness and distortion of an observed image due to the lens portion can be reduced.

### Additional Remark 10

A head-up display apparatus including:
the display apparatus according to any one of Additional Remarks 1 to 9; and
a mirror portion disposed so as to face and incline with respect to the display apparatus.

The head-up display apparatus, which uses the display apparatus described above, allows observation of a large-screen virtual image, which is difficult to realize with a single display element, over a wide viewpoint range.

### Additional Remark 11

A vehicle including
the head-up display apparatus according to Additional Remark 10.

The vehicle including the head-up display apparatus, which is thin and only causes a small amount of image deterioration at the boundary, can thus be realized.

What is claimed is:

1. A display apparatus comprising:
a first display element and a second display element arranged in a predetermined direction; and
a first lens member and a second lens member disposed so as to face and cover the first display element and the second display element, respectively, in a plan view,
wherein a gap is formed between a display region of the first display element and a display region of the second display element,
the lens members each have an edge portion disposed so as to cover the gap in the plan view,
the edge portion has a convex surface on a side opposite the display element, the convex surface deflects light output from a vicinity of the gap in the display region in a forward direction with respect to the display element, and
a relationship below is satisfied,
R1<R2
where R1 represents a radius of curvature of the convex surface at a base end, and R2 represents a radius of curvature of the convex surface at a tip.

2. The display apparatus according to claim 1, wherein
a relationship below is satisfied,
L2<L1
where L1 represents a distance between the display region of the first display element and the display region of the second display element, and L2 represents a distance from the display regions of the first display element and the second display element to the first lens member and the second lens member.

3. The display apparatus according to claim 1, wherein
the lens members each have a concave surface on a side facing the display element.

4. The display apparatus according to claim 3, wherein
the concave surface of each of the lens members, which is the surface facing the display element, is closest to a plane that is an extension of the display region.

5. The display apparatus according to claim 1, wherein
the convex surface is an aspherical surface expressed by a conic coefficient k<0.

6. The display apparatus according to claim 5, wherein
the convex surface is an elliptical surface.

7. The display apparatus according to claim 1, wherein
a radius of curvature of the convex surface gradually increases from the base end toward the tip.

8. The display apparatus according to claim 3, wherein
the edge portion is a positive meniscus lens.

9. The display apparatus according to claim 8, wherein
the concave surface is any one of a cylindrical surface, an aspherical surface, and a freeform surface.

10. A head-up display apparatus comprising:
the display apparatus according to claim 1; and
a mirror portion disposed so as to face and incline with respect to the display apparatus.

11. A vehicle comprising
the head-up display apparatus according to claim 10.
